(19) United States
(12) Patent Application Publication
(10) Pub. No.: US 2016/0186794 A1
(43) Pub. Date: Jun. 30, 2016

(54) Trim Board Screw

(71) Applicant: OMG, Inc., Agawam, MA (US)

(72) Inventors: Richard L. Belinda, Westfield, MA (US); Peter J. Shadwell, Longmeadow, MA (US); Joseph A. Pieciak, West Springfield, MA (US)

(21) Appl. No.: 14/984,727

(22) Filed: Dec. 30, 2015

Related U.S. Application Data
(60) Provisional application No. 62/097,684, filed on Dec. 30, 2014.

(51) Int. Cl. F16B 25/00; F16B 23/00

(52) U.S. Cl. CPC F16B 25/0015; F16B 25/0052; F16B 23/003

(57) ABSTRACT

A trim board fastener for composite or plastic material comprises a head having a recessed underside with a rim. A shank extends from the head and has an upper region, an unthreaded intermediate land and a lower region. The upper region has a first diameter traversed by a left hand thread having a first pitch. The lower region has a diameter smaller than the diameter of the upper region and is traversed by a double lead right hand thread which has a second pitch larger than the first pitch.

### BACKGROUND

This technology relates to fasteners which are employed for fastening composite and plastic trim board materials to a support structure. More particularly, this disclosure relates to screws employed for securing PVC material.

### BRIEF DESCRIPTION OF THE DRAWINGS

FIG. 1 is an annotated side view, diagrammed to show dimensions, of a trim board screw for plastic and composite materials;

FIG. 2 is an annotated sectional view of the screw of FIG. 1 taken along line A-A thereof;

FIG. 3 is a top plan view of the screw of FIG. 1; and

FIG. 4 is an annotated enlarged perspective view of the tip portion of the screw of FIG. 1.

### DETAILED DESCRIPTION

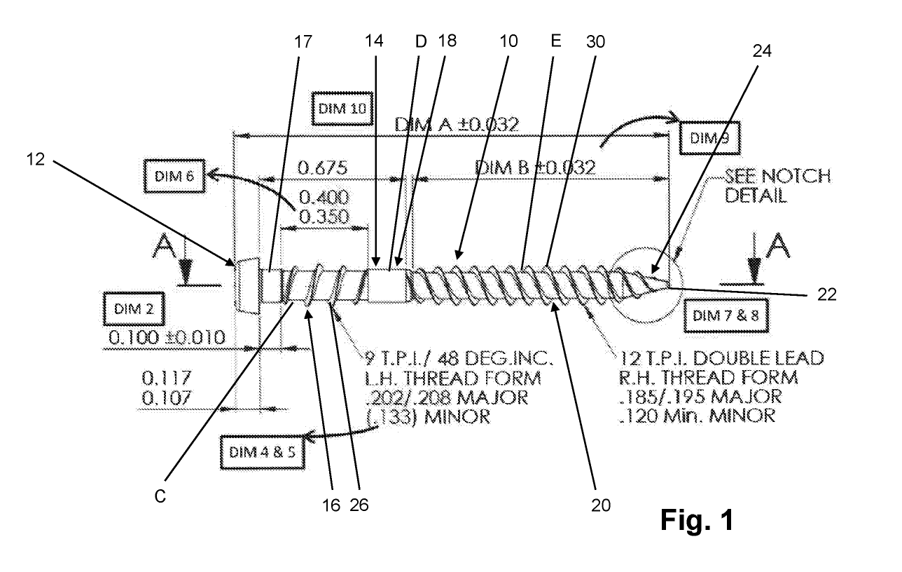

FIG. 1 shows a trim board screw 10 for plastic and composite materials. The screw 10 extends from a proximal end to a distal end and comprises a head 12, a shank 14, and a tip 24. The screw 10 is especially adapted to be driven so that the head is driven below the exterior surface of the trim board to form a counterbore above the head.

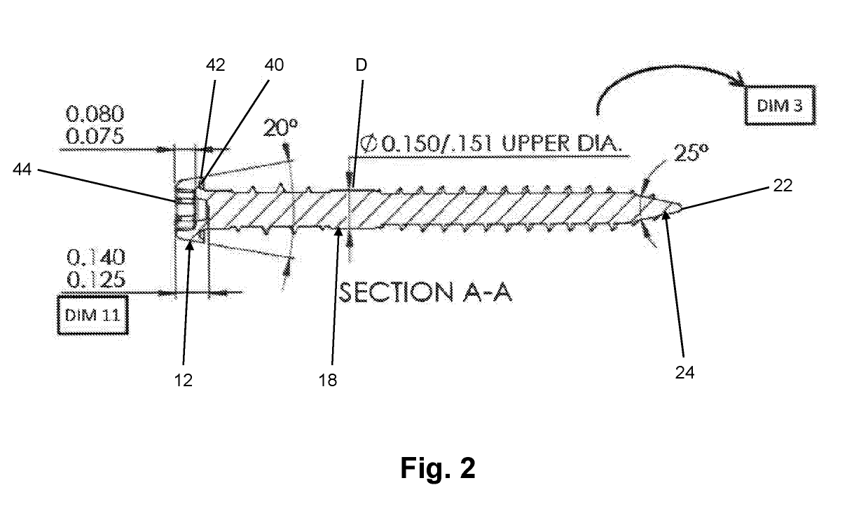

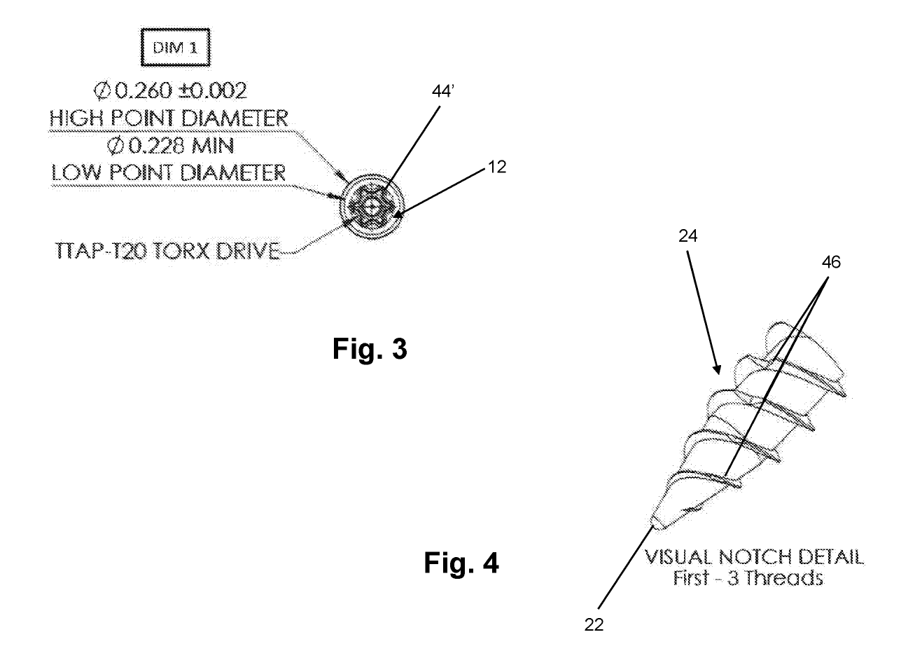

The head 12 is depicted in greater detail in FIGS. 2 and 3. Head 12, its underside, forms an annular groove 40 surrounded by a peripheral lip 42. The lip 42 facilitates entry of the head into the trim board. The head 12 tapers at a 20 degree angle radially expanding in the direction of the distal end. The head 12 can have different configurations to accommodate a variety of torque application tools. The head 12 is provided with a socket 44 for receiving a tool, such as a drill bit or a screwdriver, which can be used to drive the screw into the PVC trim board. In the embodiment depicted in FIG. 3, the head 12 is provided with a TTAP-T20 TORX® drive socket 44′ for coupling with a complementary driver.

The shank 14 comprises an upper region 16 that is closest to the head 12, an intermediate land 18 that is adjacent the upper region 16, and a lower region 20 that is adjacent to the land 18 and disposed between the land 18 and the tip 24.

Upper region 16 has a first diameter C that is less than a second diameter D of the land 18. Lower region 20 has a third diameter E that is less than the first diameter C of the upper region 16. The first C and third E diameters are substantially equal in an alternate embodiment.

The upper region 16 comprises a collar 17 and an upper thread 26. Collar 17 is an unthreaded portion of the upper region adjacent the head 12. Upper thread 26 is a continuous helical thread that starts at or near the junction of the upper region 16 and the land 18 and terminates at or near collar 17. Upper thread 26 is preferably a left hand thread with a major diameter of 0.202-0.208 inches, a minor diameter of 0.133 inches, and a pitch of 9 threads per inch with a 48 degree included angle.

Referring to FIGS. 1 and 2, the land 18 is not threaded in the depicted embodiment and has a second diameter D of 0.150-0.151 inches.

The lower region 20 contains lower thread 30. Lower thread 30 is a double continuous helical thread that starts at or near the tip 24 and terminates at or near the junction of the land 18 and the lower region 20. Lower thread 30 comprises first and second helical threads extended around the lower region 20 that are axially symmetrical and offset approximately 180 degrees from one another. Lower thread 30 is preferably a right hand double lead thread with a major diameter of 0.185-0.195 inches, a minor diameter of 0.120 inches, and a pitch of 12 threads per inch.

The tip 24 terminates in screw point 22 which is depicted in greater detail in FIG. 4. Tip 24 is tapered, decreasing in radius from lower region 20 to a sharp point 22 to allow the screw 10 to easily initially bore into material. In the embodiment depicted in FIG. 2, the tip 24 is a sharp gimlet tip exhibiting a 25 degree included angle, but other tip configurations are possible. The lower thread 30 extends from the lower region 20 into tip 24 and terminates substantially at or near the point 22. FIG. 4 shows a spiral array of notches 46 traversing the tip 24. The notches 46 extend beyond the tip 24 onto the lower region and differ in width as they traverse the screw 10.

With reference to FIG. 1, a preferred set of screw lengths A and lower region lengths B are set forth in Table 1 below for the foregoing screw 10.

TABLE 1

| FASTENER | DIM A | DIM B |
|---|---|---|
| TB002 | 2.000 | 1.175 |
| TB314 | 3.250 | 2.425 |

The foregoing specifications for one example of the screw 10 are representative of one embodiment. Other screw embodiments can also be employed.

The surface of the screw 10 is generally plated for improved resilience and corrosion resistance, but other coating techniques such as heat treating, electroplating, electrostatic coating, etc., are possible.

1. A trim board fastener for composite or plastic material comprising:
a head having a socket at a proximal end configured for receiving a tool for application of a torque and a recessed underside with a rim opposite said proximal end;
an elongated shank extending from said head away from said proximal end comprising an upper region, an unthreaded intermediate land, and a lower region, wherein said upper region is disposed adjacent said head and having a first diameter traversed by a left hand thread having a first pitch, said unthreaded intermediate land is disposed adjacent said upper region and having a second diameter larger than said first diameter, and said lower region being disposed adjacent said land and having a third diameter smaller than said first diameter and being traversed by a double lead right hand thread having a second pitch larger than said first pitch; and
a tapered distal tip terminating in a screw point adjacent said shank and being at least partially traversed by said double lead right hand thread.

2. The fastener of claim 1, further comprising at least one notch in said right hand thread on said distal tip.

3. The fastener of claim 2, further comprising a plurality of notches with at least one notch in said right hand thread on said lower region.

4. The fastener of claim 1, wherein said socket defines a six point star-like configuration.

5. The fastener of claim 1, wherein said upper region comprises an unthreaded collar adjacent said head.
